(19) United States
(12) Patent Application Publication
(10) Pub. No.: US 2019/0367644 A1
(43) Pub. Date: Dec. 5, 2019

(54) AQUEOUS POLYMER EMULSION

(71) Applicant: DSM IP Assets B.V., Heerlen (NL)

(72) Inventors: Tijs NABUURS, Echt (NL); Maud KASTELIJN, Echt (NL); Johannes Hendrikus DE BONT, Echt (NL); Gerardus Cornelis OVERBEEK, Echt (NL); Saskia Carolien VAN DER SLOT, Echt (NL); Ronald TENNEBROEK, Echt (NL); Addy MOLHOEK, Echt (NL)

(21) Appl. No.: 16/314,718

(22) PCT Filed: Jul. 3, 2017
(86) PCT No.: PCT/EP2017/066512

§ 371 Date: Jan. 2, 2019

(30) Foreign Application Priority Data
Jul. 4, 2016 (EP) 16177822.0

(51) Int. Cl. C08F 2/22; C08F 212/08; C08F 220/18; C09D 125/14; C09D 133/02; C08F 220/06; C08F 220/14; C08F 265/06; C08F 2/00

(52) U.S. Cl. CPC C08F 2/22; C08F 212/08; C08F 220/18; C09D 125/14; C09D 133/02; C08F 220/06; C08K 3/013; C08F 265/06; C08F 2/001; C08F 2220/1875; C08F 2220/1858; C08F 2220/1825; C08F 2800/20; C08F 220/14

(57) ABSTRACT

The present invention relates to an aqueous emulsion comprising at least 30 wt. % of vinyl copolymer(s) (A), said vinyl copolymer(s) (A) containing the following monomers: (I) isobornyl methacrylate and 2-octyl acrylate in a summed amount of at least 30 wt. %, in a weight ratio of isobornyl methacrylate to 2-octyl acrylate from 5:95 to 95:5; (II) no more than 70 wt. % of at least one ethylenically unsaturated monomer other than 2-octyl acrylate and isobornyl methacrylate, whereby the summed amount of (I) and (II) is 100 wt. % and whereby the amount of vinyl copolymer(s) (A) is given relative to the total weight amount of binder present in the emulsion.

The present invention relates to an emulsion comprising a vinyl copolymer binder, a process for making such emulsion, a coating obtained from the emulsion and a coated substrate.

There is a growing interest in utilizing renewable resources for environmentally friendly products and processes. It is thus desired to manufacture resins comprising biorenewable raw materials, such as itaconate monomers, and emulsions of such resins that can be used in coatings, paints, lacquers, inks, overprint varnishes, film coatings, or adhesives. Itaconic acid and its ester derivatives were identified as one of the valuable chemicals that can be derived from biomass, which may be potentially useful also in relation to producing “green” polymers for coating formulations. For example, prior art documents WO2011073417, WO2013113937 and WO2013113936 describe the use of dialkylesters of itaconic acid as monomer in vinyl copolymer binder. It has however been found that the use of dialkylesters of itaconic acid in vinyl copolymer binders may result in a coating with low chemical resistance (in particular ethanol resistance), low early blocking resistance and/or low early water resistance. A high (early) water resistance is regarded as a very important property of a coating as migration of water through the coating may result in delamination of the coating from the substrate and/or in affecting the substrate. For example when a wooden substrate is used, a too low (early) water resistance of the coating may result in rotting of the wooden substrate. Also the (early) blocking resistance of a coating is a very important coating property. Blocking resistance combats the tendency of coatings to stick together (or block). Poor anti-blocking properties cause the two contacting coatings to stick, resulting in tearing or peeling of the coatings upon separation. A high early blocking resistance increases production efficiency and avoids potential coating damages when separating two coated surfaces that are stacked or placed in contact with one another during storage, packaging and/or shipping. Coatings also must be chemically resistant, such as resistant to water and to ethanol, for example to protect the coating and the substrate from ethanol containing cleaning agents and/or ethanol containing beverages/liquids.

The object of the present invention is to provide an aqueous emulsion of a vinyl copolymer binder which may contain biobased monomers, other than alkyl esters of itaconic acid, and which vinyl copolymer binder results in a coating with improved chemical resistance (in particular improved ethanol resistance), improved early blocking resistance and/or improved early water resistance (compared to when applying a similar aqueous emulsion of a vinyl copolymer binder containing alkyl esters of itaconic acid, such as for example dimethylitaconate or dibutylitaconate, and having the same or substantially the same glass transition temperature T_{g} than the vinyl copolymer binder as used in the present invention).

It has surprisingly been found that the use of a vinyl copolymer binder containing 2-octylacrylate in combination with isobornyl methacrylate in amounts as claimed results in coatings with improved chemical resistance (in particular the ethanol resistance), improved early blocking resistance and/or improved early water resistance (compared to the use of a vinyl copolymer binder having the same or substantially the same glass transition temperature T_{g} and optionally the same or substantially the same biobased carbon content but containing alkyl esters of itaconic acid, such as for example dimethylitaconate or dibutylitaconate). An advantage of the present invention is that the biobased carbon content of the vinyl copolymer binder can be increased, while the chemical resistance, the early blocking resistance and/or the early water resistance can be retained or even improved.

Accordingly, the present invention provides an aqueous polymer emulsion for preparing a coating composition, whereby the aqueous emulsion comprises vinyl copolymer(s) (A) derived from the following monomers:
(I) isobornyl methacrylate and 2-octyl acrylate in a summed amount of at least 30 wt. %, whereby the weight ratio of isobornyl methacrylate to 2-octyl acrylate is from 5:95 to 95:5;
(II) no more than 70 wt. % of at least one ethylenically unsaturated monomer other than 2-octyl acrylate and isobornyl methacrylate,
   whereby the summed amount of (I) and (II) is 100 wt. %, i.e. the amounts of (I) and (II) are given relative to the total weight amount of the monomers used to prepare the vinyl copolymer (A), and whereby the amount of vinyl copolymer(s) (A) is preferably at least 30 wt. % relative to the total weight amount of polymeric binder present in the emulsion.

The structural formula of 2-octyl acrylate is the following:

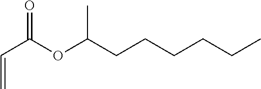

The structural formula of isobornyl methactylate is the following:

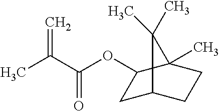 [SMILES: C=C(C)C(=O)OC1CC2CCC1(C)C2(C)C]

All ranges of amounts are intended to include each and every point within the range.

By a vinyl copolymer herein is meant a copolymer derived from the addition polymerization (using a free radical process) of ethylenically unsaturated compounds having a polymerisable carbon-carbon double bond. The aqueous emulsion comprising the vinyl copolymer(s) (A) as defined herein is also referred herein as aqueous polymer emulsion.

As is well known in the art (see for example handbook Organic Coatings: Science and Technology second addition; 1999; John Wiley and Sons; Zeno W. Wicks, Frank N. Jones, S. Peter Pappas, page 4), the binder of a coating composition is known to be the film-forming element of a coating. Binders are the materials that form the continuous film that adheres to the substrate (the surface being coated), binds together the other substances in the coating to form a film, and that presents an adequately hard outer surface. Binders of coating compositions obtained from emulsions according to the invention are known to be polymeric. The terms “binder” and “polymeric binder” can therefore be used interchangeably herein. The binder present in the emulsion of the invention preferably consists of vinyl copolymer (A) and optionally (in case present) polyurethane, polyester, polyesteramide, polyamide and/or vinyl copolymer different from vinyl copolymer (A). The binder present in the coating composition of the present invention (comprising the emulsion of the present invention) also preferably consists of vinyl copolymer (A) and optionally (in case present) polyurethane, polyester, polyesteramide, polyamide and/or vinyl copolymer different from vinyl copolymer (A).

Isobornyl methacrylate and 2-octyl acrylate are commercially available as partially biobased monomers. As used herein, biobased monomers are monomers containing biobased carbon. Biobased monomers useful with the compositions described herein include monomers containing at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. %, at least 80 wt. %, at least 85 wt. %, at least 90 wt. %, or at least 95 wt. % biobased carbon (based on the total carbon content). As used herein, the term biobased carbon is intended to mean carbon obtained from a biological source rather than a fossil oil based source. The biobased content of a monomer, a copolymer, or a copolymer composition can be determined using a method such as ASTM D6866-08. Fossil based carbon contains essentially no ¹⁴C because its age is much greater than the 5,730 year half-life of ¹⁴C. Thus, the presence and level of ¹⁴C in a composition provides a direct measure of the amount of carbon that originated from a source other than a fossil fuel, i.e., the level of biobased carbon in the composition. The term “substantially the same” as used herein may refer to a quantity or entity to imply a large amount or proportion thereof. Where it is relevant in the context in which it is used “substantially the same” is to be understood to mean quantitatively (in relation to whatever quantity or entity to which it refers in the context of the description) a proportion of at least 80%, preferably at least 85%, more preferably at least 90%, most preferably at least 95%, especially at least 98%, for example about 100% of the relevant whole.

Preferably, the vinyl copolymer(s) (A) is derived from the following monomers:
(I) isobornyl methacrylate and 2-octyl acrylate in a summed amount of at least 40 wt. %, whereby the weight ratio of isobornyl methacrylate to 2-octyl acrylate is from 5:95 to 95:5;
(II) no more than 60 wt. % of at least one ethylenically unsaturated monomer other than 2-octyl acrylate and isobornyl methacrylate,
   whereby the summed amount of (I) and (II) is 100 wt. %, i.e. the amounts of (I) and (II) are given relative to the total weight amount of the monomers used to prepare the vinyl copolymer (A).

The weight ratio of isobornyl methacrylate to 2-octyl acrylate in the vinyl copolymer(s) (A) is from 5:95 to 95:5, preferably from 15:85 to 85:15, more preferably from 15:85 to 70:30.

The amount of vinyl copolymer(s) (A) is preferably at least 30 wt. %, more preferably at least 50 wt. % and more preferably at least 70 wt. %, relative to the total weight amount of binders present in the emulsion according to the invention.

The glass transition temperature of the vinyl copolymer(s) (A) is preferably in the range from −30° C. to 80° C., more preferably in the range from −20° C. to 60° C. As is well known, the glass transition temperature of a polymer is the temperature at which it changes from a glassy, brittle state to a plastic, rubbery state. As used herein, the glass transition temperature is determined by calculation by means of the Fox equation. Thus the T_{g} in degrees Kelvin, of a copolymer having “n” copolymerised comonomers is given by the weight fractions W of each comonomer type and the T_{g}'s of the homopolymers (in Kelvin) derived from each comonomer according to the equation:

$$\frac{1}{Tg} = \frac{{W}_{1}}{{Tg}_{1}} + \frac{{W}_{2}}{{Tg}_{2}} + … + \frac{{W}_{n}}{{Tg}_{n}}$$

The calculated T_{g} in degrees Kelvin may be readily converted to ° C.

The weight average molecular weight of vinyl copolymer(s) (A) is preferably higher than 50,000 g/mol, more preferably higher than 80,000 g/mol, even more preferably higher than 200,000 g/mol; preferably lower than 10,000,000 g/mol and more preferably lower than 4,000,000 g/mol.

As used herein, the weight average molecular weight is determined by SEC (Size Exclusion Chromatography) analyses. The SEC analyses were performed on an Alliance Separation Module (Waters 2690), including a pump, autoinjector, degasser, and column oven. The eluent was N-methylpyrrolidone (NMP) with the addition of 0.01M LiBr and 8% hexafluoroisopropanol. The injection volume was 150 μl. The flow was established at 1.0 ml/min. Three PLgel Mixed B columns (performed with a differential refractive index detector (Waters 410)) were used. The sample solutions were prepared with a concentration of 5 mg solids in 1 ml NMP (+0.01M LiBr, 8% hexafluoroisopropanol), and the samples were dissolved for a period of 24 hours. Calibration is performed with polystyrene standards (polymer standard services), ranging from 500 to 2,000,000 gram/mol. The calculation was performed with Empower 3 software (Waters) with a third order calibration curve. The obtained molar masses are polystyrene equivalent molar masses (gram/mol).

In an embodiment of the invention, the binder of the aqueous emulsion mainly contains, preferably consists of vinyl copolymer(s) (A).

In this embodiment, the amount of vinyl copolymer(s) (A) present in the emulsion is preferably 100 wt. %, relative to the total weight amount of binder present in the emulsion according to the invention. Hence, in this embodiment, the emulsion preferably does not contain any other binder than vinyl copolymer(s) (A). The monomers (I) (i.e. isobornyl methacrylate and 2-octyl acrylate) are present in the vinyl copolymer(s) (A) in a summed amount of at least 30 wt. % and in a weight ratio of isobornyl methacrylate to 2-octyl acrylate from 5:95 to 95:5, and monomers (II) in the vinyl copolymer(s) (A) preferably consists of the following monomers:
(IIa) from 0.1 to 15 wt. %, preferably from 0.1 to 10 wt. % and more preferably from 0.1 to 5 wt. % of carboxylic acid functional ethylenically unsaturated monomer(s);
(IIb) from 0 to 5 wt. % of ethylenically unsaturated crosslinkable monomer, different from (IIa);
(IIc) from 0 to 5 wt. % of ethylenically unsaturated wet adhesion promotor monomer, different from (IIa) and (IIb);
(IId) from 45 to 69.9 wt. %, preferably from 50 to 69.9 wt. % and more preferably from 55 to 69.9 wt. % of ethylenically unsaturated monomer(s), different from (IIa), (IIb) and (IIc);
   whereby the amounts of (IIa), (IIb), (IIc) and (IId) are given relative to the total amount of (I) and (II).

More preferably, the monomers (I) (i.e. isobornyl methacrylate and 2-octyl acrylate) are present in the vinyl copolymer(s) (A) in a summed amount of at least 40 wt. % and in a weight ratio of isobornyl methacrylate to 2-octyl acrylate from 5:95 to 95:5, and the monomers (II) in the vinyl copolymer(s) (A) preferably consists of the following monomers
(IIa) from 0.1 to 15 wt. %, preferably from 0.1 to 10 wt. % and more preferably from 0.1 to 5 wt. % of carboxylic acid functional ethylenically unsaturated monomer(s);
(IIb) from 0 to 5 wt. % of ethylenically unsaturated crosslinkable monomer, different from (IIa);
(IIc) from 0 to 5 wt. % of ethylenically unsaturated wet adhesion promotor monomer, different from (IIa) and (IIb);
(IId) from 35 to 59.9 wt. %, preferably from 40 to 59.9 wt. % and more preferably from 45 to 59.9 wt. % of ethylenically unsaturated monomer(s), different from (IIa), (IIb) and (IIc);
   whereby the amounts of (IIa), (IIb), (IIc) and (IId) are given relative to the total amount of (I) and (II).

In this embodiment, the glass transition temperature of the vinyl copolymer(s) (A) is preferably in the range from 20° C. to 60° C., more preferably in the range from 40° C. to 60° C. Alternatively, the glass transition temperature of the vinyl copolymer(s) (A) is in the range from −20° C. to 20° C.

Monomer (IIa) is preferably selected from the group consisting of itaconic acid, acrylic acid, methacrylic acid, R-carboxyethyl acrylate and combinations thereof. More preferably, monomer (IIa) is acrylic acid and/or methacrylic acid.

Monomers (IIb), (IIc) and (IId) are preferably selected from the group consisting of acrylates, methacrylates, arylalkylenes and any mixture thereof. Monomer (IId) is preferably selected from the group consisting of methyl (meth)acrylate, ethyl (meth)acrylate, butyl (meth)acrylate, styrene and combinations thereof.

The vinyl copolymer(s) (A) preferably does not contain monomer (IIb) and/or monomer (IIc).

The aqueous emulsion of the invention may contain one or more vinyl copolymers (A) as defined above. In case more than one vinyl copolymer (A) is present, the vinyl copolymers (A) are intentionally present in different particles or preferably at least a part of the different vinyl copolymers (A) are intentionally present in the same particle(s). The intentional presence of different vinyl copolymers (A) in the same particle(s) is preferably obtained by emulsion polymerization of a first vinyl copolymer (A1) and emulsion polymerization of a second vinyl copolymer (A2) in the presence of the first vinyl copolymer (A1), whereby both vinyl copolymer (A1) and vinyl copolymer (A2) containing monomers (I) and (II) as defined above. Preferably, the glass transition temperature of the vinyl copolymer (A1) is preferably in the range from −20° C. to 20° C. and the glass transition temperature of the vinyl copolymer (A2) is preferably in the range from 60° C. to 120° C. Preferably, the weight ratio of vinyl copolymer (A1) and vinyl copolymer (A2) is in the range from 60:40 to 90:10.

### Polymer (B)

In another embodiment of the invention, the emulsion further comprises at least one second polymeric binder (B) different from vinyl copolymer (A), whereby the weight ratio of vinyl copolymer(s) (A) to polymer(s) (B) is preferably in the range from 90:10 to 50:50, and whereby the total amount of vinyl copolymer(s) (A) and polymer(s) (B) present in the emulsion is preferably 100 wt. %, relative to the total weight amount of binder present in the emulsion. Hence, in this embodiment, the emulsion preferably does not contain any other binder than vinyl copolymer(s) (A) and polymer(s) (B). The amount of vinyl copolymer (A) is preferably at least 30 wt. %, more preferably at least 50 wt. %, even more preferably at least 70 wt. %, whereby the amount of vinyl copolymer (A) is given relative to the total weight amount of binders present in the emulsion and hence preferably relative to the total weight amount of vinyl copolymer(s) (A) and polymer(s) (B) present in the emulsion.

The aqueous emulsion containing vinyl copolymer(s) (A) and polymer(s) (B) as binder can be made in various ways. Especially preferred methods comprise: 1) blending an aqueous emulsion containing polymer (B) with an aqueous emulsion containing vinyl copolymer (A) as described above, or preferably 2a) polymerizing a monomer composition containing monomers (I) and (II) as described above in the presence of polymer (B) or 2b) polymerizing a monomer composition to obtain polymer (B) in the presence of vinyl copolymer (A). In approach 1), vinyl copolymer (A) is intentionally present in different particles than polymer (B). In approach 2) the vinyl copolymer (A) and polymer (B) are by intend preferably present in the same particle(s).

Polymer (B) can be any polymeric binder and is preferably a polyester, a polyesteramide, a polyamide, a polyurethane or a vinyl copolymer (B). More preferably Polymer (B) is a vinyl copolymer (B).

### Polyurethane as Polymer (B)

Polyurethane polymers are typically prepared from reactants which comprise an organic polyisocyanate component (usually a diisocyanate component although tri or higher functionality isocyanates can be employed) and a component comprising a compound(s) bearing NCO-reactive groups, particularly a macro or polymeric polyol (number average molecular weight Mn>=500), optionally with the inclusion of a low molecular weight polyol (Mn<=499). Monoisocyanates and monools may also be included in the synthesis.

The aqueous polyurethane acrylate copolymer emulsion can be made in various ways. Especially preferred methods comprise: 1) blending a polyurethane emulsion or a urethane-acrylic copolymer emulsion not according to the invention with a vinyl copolymer (A) emulsion according to the invention, or 2) polymerizing a monomer composition containing monomers (I) and (II) as described above in the presence of a polyurethane emulsion. This latter approach can be operated in three ways. 2a) either the polyurethane resin(s) is dissolved in the monomer phase, after which this mixture is emulsified and the monomers are polymerised, or 2b) monomer is added batch wise or semi-batch wise to a pre-made polyurethane emulsion. Finally, 2c) a combination of processes 2a and 2b is possible, where the polyurethane resin(s) is dissolved in part of the monomers, after which the mixture is emulsified, followed by batch or semi-batch addition of the remaining monomer phases, while the polymerization is ongoing.

The most preferred process is a batch process, either according to process 2a) or 2b). Most preferred is that at least part of the monomers (I) and/or (II) is used to dissolve the polyurethane prior to emulsification.

Other features of the polyurethane (B) are conventional and well known to those skilled in the art (for example as described in WO99/016805 (the contents of which is hereby incorporated herein by reference)).

Thus for example the polyurethane (B) can be made emulsifyable by neutralization of acid groups in the polyurethane backbone or by addition of a polymer surfactant or a regular low molecular weight surfactant. In the case that acid groups on the polyurethane backbone are neutralized, this can be done with organic amines, such as for instance triethyl amine, or dimethyl butyl amine, or with an inorganic base, such as LiOH, NaOH or KOH. It is also possible to introduce to the polyurethane backbone emulsifiable groups that have a very low pKa, such as for instance sulphate or sulphonate groups, or phosphate or phosphonate groups. Finally, emulsifiable groups that can be introduced to the polyurethane backbone are non-ionically stabilizing groups, such as polyethylene glycol chains or methyl ether capped polyethylene glycol chains.

Typically, the base-acid ratio is between 0.5 and 1.5, more preferably between 0.8 and 1.2. In those cases where the base-acid ratio is less than 0.8, additional surfactant (either polymeric or low molecular weight) can be used to aid in the emulsification.

Preferably, the acid value of the polyurethane (B) is less than 90 mg KOH/g of solid polyurethane, more preferably less than 80 mg KOH/g, most preferably between 2 and 45 mg KOH/g, and typically between 10 and 35 mg KOH/g of solid polyurethane. As used herein, the acid value of the polyurethane (B) is determined according to DTN-EN ISO 2114.

Although in a preferred embodiment the polyurethane (B)—having at least part of the acid groups neutralized—will serve as the colloidal stabilizer for the polyvinyl composition, the aqueous copolymer composition may also or instead comprise conventional surfactants.

### Polyester, Polyesteramide or Polyamide as Polymer (B)

The polyester, polyesteramide or polyamide (B) is preferably formed by the reaction of the following components:
(1) at least one difunctional aromatic, saturated aliphatic or saturated alicyclic dicarboxylic acid;
(2) at least one difunctional sulfomonomer containing at least one metal sulfonate group attached to an aromatic nucleus, wherein the functional groups are hydroxy or carboxyl, this monomer being present in an amount from about 4 to about 25 mol %, based on a total of all acid and hydroxyl equivalents being equal to 200 mol %;
(3) at least one difunctional reactant selected from a diol, diamine, an aminoalcohol or a mixture thereof.

Component (1) is at least one difunctional aromatic, saturated aliphatic or saturated alicyclic dicarboxylic acid or a mixture thereof. The dicarboxylic acid component of the polyester, polyamide, or polyesteramide may be selected from aliphatic dicarboxylic acids, alicyclic dicarboxylic acids, aromatic dicarboxylic acids or mixtures of two or more of these acids. Examples of such dicarboxylic acids, include succinic, glutaric, adipic, azelaic, sebacic, 1,4-cyclohexanedicarboxylic, phthalic, terephthalic and isophthalic acid. Terephthalic acid and isophthalic acid are preferred as the dicarboxylic acid component of the polyester. It should be understood that use of the corresponding acid anhydrides, esters, and acid chlorides of these acids is included in the term “dicarboxylic acid.”

Component (2) is at least one difunctional sulfomonomer containing at least one metal sulfonate group attached to an aromatic nucleus wherein the functional groups are hydroxy or carboxyl, the sulfomonomer being present in an amount from about 4 to about 25 mol %, based on a total of all acid and hydroxyl equivalents being equal to 200 mol %.

The difunctional sulfomonomer component of the polyester may advantageously be a dicarboxylic acid or an ester thereof containing a metal sulfonate group, a glycol containing a metal sulfonate group or a hydroxy acid containing a metal sulfonate group or a hydroxy acid containing a metal sulfate group. The metal ion of the sulfonate salt may be Na+, Li+, K+ and the like. When a monovalent alkali metal ion is used, the resulting polyesters are less readily dissipated by cold water and more readily dissipated by hot water. When a divalent or a trivalent metal ion is used the resulting polyesters are not ordinarily easily dissipated by cold water but are more readily dissipated in hot water. It is possible to prepare the polyester using, for example, a sodium sulfonate salt and latex by ionexchange replacement of this ion with a different ion, and thus alter the characteristics of the polymer. The difunctional monomer component may also be referred to the difunctional sulfomonomer and is further described herein below.

Advantageous difunctional sulfomonomer components are those wherein the sulfonate salt group is attached to an aromatic acid nucleus such as benzene, naphthalene, diphenyl, oxyphenyl, sulfonyldiphenyl or methylenediphenyl nucleus. Preferred results are obtained through the use of sulfophthalic acid, sulfoterephthalic acid, sulfoisophthalic acid, 4-sulfonaphthalene-2,7-dicarboxylic acid, and their esters.

Particularly superior results are achieved when the difunctional sulfomonomer component is 5-sodiosulfoisophthalic acid or its esters. Component (3) is at least one difunctional reactant selected from a diol, diamine, an aminoalcohol or a mixture thereof. A large variety of diol, diamine, and aminoalcohol monomers suitable for producing polyesters, polyamides, and polesteramides are known in the art. Suitable classes of diols preferably include C2-C20 alkylene glycols, polyethyleneglycols, polypropylene glycols, polybutylene glycols, and aromatic diols. Preferred species of diols include ethylene glycol, 1,3-propanediol, 1,4-butanediol, 1,5-pentanediol, 1,6-hexanediol, 2,2-dimethyl-1,3-propanediol, 1,4-cyclohexanedimethanol, 1,3-cyclohexanedimethanol, 2,2,4,4-tetramethylcyclobutanediol, 1,3-propylene glycol, diethylene glycol, triethylene glycol, or bisphenol A. Lower alkyl ester derivatives of the above-described diols are also suitable for polymerization, and preferably include compounds such as ethyleneglycol diacetate.

Suitable diamine moieties preferably include but are not limited to ethylene diamine and 1,6-diaminohexane. Species of suitable aminoalcohols preferably include 2-aminoethanol, 5-amino-1-pentanol, and 6-amino-1-hexanol.

The polyester, polyesteramide or polyamide (B) as described above is optionally modified by at least one multifunctional branching agent as for example described in U.S. Pat. No. 6,255,366. The polyester, polyesteramide or polyamide (B) is preferably obtained by bulk polymerization.

When polymer (B) is a polyester, polyesteramide or polyamide, the emulsion of the present invention is preferably prepared by adding the monomers (I) and (II) of vinyl copolymer (A) to an aqueous dispersion of the water-dispersible polyester, polyesteramide or polyamide (B) and polymerized by free radical initiation preferably using emulsion polymerization.

In case the Polymer (B) is a polyurethane, the glass transition temperature of the vinyl copolymer (A) is preferably in the range from 0 to 120° C. In case the Polymer (B) is a poly(ester)amide, the glass transition temperature of the vinyl copolymer (A) is preferably in the range from −10 to 50° C.

### Vinyl Copolymer as Polymer (B)

Preferably, the second polymer (B) is a vinyl copolymer (B) different from vinyl copolymer (A), i.e. the vinyl copolymer (B) does not contain the combination of isobornyl methacrylate and 2-octyl acrylate.

The glass transition temperature of vinyl copolymer (B) is preferably higher than the glass transition temperature of vinyl copolymer (A), whereby the difference in glass transition temperature between vinyl copolymer (B) and vinyl copolymer (A) is preferably at least 20° C., more preferably at least 30° C., even more preferably at least 40° C. The glass transition temperature of the vinyl copolymer (A) is preferably in the range from −30° C. to 40° C., more preferably between −20° C. and 20° C.

Preferably, the preparation of the vinyl copolymer (A) and vinyl copolymer (B) is effected such that vinyl copolymer (A) and vinyl copolymer (B) are intentionally present in the same particle. This is preferably achieved by effecting the preparation of vinyl copolymer (A) and vinyl copolymer (B) sequentially, whereby the vinyl copolymer (A) is obtained in the presence of vinyl copolymer (B) or the vinyl copolymer (B) is obtained in the presence of vinyl copolymer (A).

In one embodiment, the vinyl copolymer (B) is obtained in the presence of vinyl copolymer (A), whereby the vinyl copolymer (A) and vinyl copolymer (B) are obtained by a process comprising steps:
a) a first polymerization step, to form the vinyl copolymer (A);
b) a second polymerization step effected in the presence of the resulting first phase vinyl copolymer (A) obtained in step a) to form the second phase vinyl copolymer (B).

In this embodiment, monomer (II) in the vinyl copolymer (A) preferably contains from 0.1 to 15 wt. %, preferably from 0.1 to 10 wt. %, more preferably from 1 to 5 wt. % of carboxylic acid functional ethylenically unsaturated monomer, whereby the amount of carboxylic acid functional ethylenically unsaturated monomer is given relative to the total amount of (I) and (II).

The monomers (I) (i.e. isobornyl methacrylate and 2-octyl acrylate) are present in the vinyl copolymer (A) in a summed amount of at least 30 wt. % and in a weight ratio of isobornyl methacrylate to 2-octyl acrylate from 5:95 to 95:5, and the monomers (II) in the vinyl copolymer (A) in this embodiment preferably consists of the following monomers:
(IIa) from 0.1 to 15 wt. %, preferably from 0.1 to 10 wt. % and more preferably from 1 to 5 wt. % of carboxylic acid functional ethylenically unsaturated monomer(s);
(IIb) from 0 to 5 wt. % of ethylenically unsaturated crosslinkable monomer, different from (IIa);
(IIc) from 0 to 5 wt. % of ethylenically unsaturated wet adhesion promotor monomer, different from (IIa) and (IIb);
(IId) from 45 to 69.9 wt. %, preferably from 50 to 69.9 wt. % and more preferably from 55 to 69 wt. % of ethylenically unsaturated monomer(s), different from (IIa), (IIb) and (IIc);
   whereby the amounts of (IIa), (IIb), (IIc) and (IId) are given relative to the total amount of (I) and (II). More preferably, the monomers (I) (i.e. isobornyl methacrylate and 2-octyl acrylate) are present in the vinyl copolymer (A) in a summed amount of at least 40 wt. % and in a weight ratio of isobornyl methacrylate to 2-octyl acrylate from 5:95 to 95:5, and the monomers (II) in the vinyl copolymer (A) preferably consists of the following monomers
(IIa) from 0.1 to 15 wt. %, preferably from 0.1 to 10 wt. % and more preferably from 1 to 5 wt. % of carboxylic acid functional ethylenically unsaturated monomer(s);
(IIb) from 0 to 5 wt. % of ethylenically unsaturated crosslinkable monomer, different from (IIa);
(IIc) from 0 to 5 wt. % of ethylenically unsaturated wet adhesion promotor monomer, different from (IIa) and (IIb);
(IId) from 35 to 59.9 wt. %, preferably from 40 to 59.9 wt. % and more preferably from 45 to 59 wt. % of ethylenically unsaturated monomer(s), different from (IIa), (IIb) and (IIc);
   whereby the amounts of (IIa), (IIb), (IIc) and (IId) are given relative to the total amount of (I) and (II). Monomers (IIa), (IIb), (IIc) and (IId) are preferably as described above. The vinyl copolymer (A) preferably do not contain monomer (IIb) and/or monomer (IIc).

In this embodiment, the vinyl copolymer (B) preferably consists of the following monomers:
(IB) from 0.1 to 10 wt. %, preferably from 0.1 to 5 wt. %, more preferably from 1 to 3.5 wt. % of carboxylic acid functional ethylenically unsaturated monomer;
(IIB) from 90 to 99.9 wt. %, preferably from 95 to 99.9 wt. %, more preferably from 96.5 wt. % to 99 wt. % of ethylenically unsaturated monomer, different from (IB);
   whereby the amounts of (IB) and (IIB) are given relative to the total weight amount of monomers used to prepare the vinyl copolymer (B). Monomer (IB) is preferably selected from the group consisting of itaconic acid, acrylic acid, methacrylic acid, R-carboxyethyl acrylate and combinations thereof. More preferably, monomer (IB) is acrylic acid and/or methacrylic acid. Monomers (IIB) are preferably selected from the group consisting of acrylates, methacrylates, arylalkylenes and any mixture thereof. Monomer (IIB) may include wet adhesion promoting ethylenically unsaturated monomer in an amount of at most 10 wt. %, preferably in an amount of at most 6 wt. % (relative to the total weight amount of monomers used to prepare the vinyl copolymer (B)). Monomer (IIB) may include ethylenically unsaturated crosslinkable monomer in an amount of at most 15 wt. %, preferably in an amount of at most 10 wt. % (relative to the total weight amount of monomers used to prepare the vinyl copolymer (B)).

In another embodiment, the vinyl copolymer (A) is obtained in the presence of vinyl copolymer (B), whereby the vinyl copolymer (A) and vinyl copolymer (B) are obtained by a process comprising steps:
a) a first polymerization step, to form the vinyl copolymer (B);
b) a second polymerization step effected in the presence of the resulting first phase vinyl copolymer (B) obtained in step a) to form the second phase vinyl copolymer (A).

In this embodiment, the vinyl copolymers (A) and (B) are preferably obtained by a process comprising steps:
a) preparing a first phase carboxylic acid-functional vinyl copolymer (B) by emulsion polymerization of a monomer composition (B) in the presence of a chain-transfer agent, whereby monomer composition (B) contains:
   Bi) at least one carboxylic acid functional ethylenically unsaturated monomer; and
   Bii) at least one ethylenically unsaturated monomer different than Bi); and
b) preparing a second phase vinyl copolymer (A) by emulsion polymerization of a monomer composition A in the presence of the resulting first phase vinyl copolymer (B) from step a) where the monomer composition A consists of the following monomers:
   (I) isobornyl methacrylate and 2-octyl acrylate in a summed amount of at least 30 wt. %, preferably at least 40 wt. %, in a weight ratio of isobornyl methacrylate to 2-octyl acrylate from 5:95 to 95:5;
   (II) no more than 70 wt. %, preferably no more than 60 wt. %, of at least one ethylenically unsaturated monomer other than 2-octyl acrylate and isobornyl methacrylate, whereby the summed amount of (I) and (II) is 100 wt. %;
      where the acid value of vinyl copolymer (A) is lower than the acid value of vinyl copolymer (B); the weight average molecular weight (Mw) of vinyl copolymer (A) is higher than the weight average molecular weight (Mw) of vinyl copolymer (B); and where at least part of the carboxylic acid groups of vinyl copolymer (B) are deprotonated to obtain ionic or potentially ionic water-dispersing groups prior to step b). The monomers (I) (i.e. isobornyl methacrylate and 2-octyl acrylate) are present in the vinyl copolymer (A) in a summed amount of at least 30 wt. % and in a weight ratio of isobornyl methacrylate to 2-octyl acrylate from 5:95 to 95:5, and the monomers (II) in the vinyl copolymer (A) in this embodiment preferably consists of the following monomers:
(IIa) from 0 to 5 wt. % and more preferably from 0 to 3 wt. % of carboxylic acid functional ethylenically unsaturated monomer(s), and most preferably 0 wt. %;
(IIb) from 0 to 5 wt. % of ethylenically unsaturated crosslinkable monomer, different from (IIa);
(IIc) from 0 to 5 wt. % of ethylenically unsaturated wet adhesion promotor monomer, different from (IIa) and (IIb);
(IId) from 55 to 70 wt. %, preferably from 57 to 70 wt. % and more preferably 70 wt. % of ethylenically unsaturated monomer(s), different from (IIa), (IIb) and (IIc);
   whereby the amounts of (IIa), (IIb), (IIc) and (IId) are given relative to the total amount of (I) and (II). The monomers (I) (i.e. isobornyl methacrylate and 2-octyl acrylate) are preferably present in the vinyl copolymer (A) in a summed amount of at least 40 wt. % and in a weight ratio of isobornyl methacrylate to 2-octyl acrylate from 5:95 to 95:5, and the monomers (II) in the vinyl copolymer (A) in this embodiment preferably consists of the following monomers:
(IIa) from 0 to 5 wt. % and more preferably from 0 to 3 wt. % of carboxylic acid functional ethylenically unsaturated monomer(s), and most preferably 0 wt. %;
(IIb) from 0 to 5 wt. % of ethylenically unsaturated crosslinkable monomer, different from (IIa);
(IIc) from 0 to 5 wt. % of ethylenically unsaturated wet adhesion promotor monomer, different from (IIa) and (IIb);
(IId) from 45 to 60 wt. %, preferably from 47 to 60 wt. % and more preferably 60 wt. % of ethylenically unsaturated monomer(s), different from (IIa), (IIb) and (IIc);
   whereby the amounts of (IIa), (IIb), (IIc) and (IId) are given relative to the total amount of (I) and (II). Monomers (IIa), (IIb), (IIc) and (IId) are preferably as described above. In this embodiment, the vinyl copolymer (A) preferably do not contain monomer (IIa) and preferably also do not contain monomer (IIb) and/or monomer (IIc).

In this embodiment, the vinyl copolymer (B) preferably consists of the following monomers:
(IB) from 0.1 to 15 wt. %, preferably from 5 to 12 wt. %, more preferably from 5 to 10 wt. % of carboxylic acid functional ethylenically unsaturated monomer;
(IIB) from 85 to 99.9 wt. %, preferably from 88 to 95 wt. %, more preferably from 90 wt. % to 95 wt. % of ethylenically unsaturated monomer, different from (IB);
   whereby the amounts of (IB) and (IIB) are given relative to the total weight amount of monomers used to prepare the vinyl copolymer (B). Monomer (IB) is preferably selected from the group consisting of itaconic acid, acrylic acid, methacrylic acid, R-carboxyethyl acrylate and combinations thereof. More preferably, monomer (IB) is acrylic acid and/or methacrylic acid. Most preferably, monomer (IB) is methacrylic acid. Monomers (IIB) are preferably selected from the group consisting of acrylates, methacrylates, arylalkylenes and any mixture thereof. Monomer (IIB) may include wet adhesion promoting ethylenically unsaturated monomer in an amount of at most 10 wt. %, preferably in an amount of at most 6 wt. % (relative to the total weight amount of monomers used to prepare the vinyl copolymer (B)). Monomer (IIB) may include ethylenically unsaturated crosslinkable monomer in an amount of at most 15 wt. %, preferably in an amount of at most 10 wt. % (relative to the total weight amount of monomers used to prepare the vinyl copolymer (B)).

In this embodiment, vinyl copolymer (B) has a weight average molecular weight (Mw) less than 100,000 g/mole and higher than 2,000 g/mol, preferably less than 75,000 g/mol, more preferably less than 50,000 g/mol and the weight average molecular weight of vinyl copolymer (B) is most preferably from 10,000 to 35,000 g/mol.

Ethylencially unsaturated crosslinkable monomers may be present in vinyl copolymer (A) and/or vinyl copolymer (B). Ethylencially unsaturated crosslinkable monomers contain functional groups for imparting crosslinkablilty when the aqueous emulsion is subsequently dried. The functional groups for providing crosslinkability are preferably selected from epoxy, hydroxyl, ketone and aldehyde groups. Comonomer(s) with functional groups for imparting crosslinkablilty is (are) preferably selected from glycidyl (meth)acrylate, hydroxyalkyl (meth)acrylates such as hydroxyethyl (meth)acrylate, acrolein, methacrolein and methyl vinyl ketone, the acetoacetoxy esters of hydroxyalkyl (meth)acrylates such as acetoacetoxyethyl (meth)acrylate, and keto-containing amides such as diacetone acrylamide. The functional group for providing crosslinkability is most preferably a ketone group. In case comonomer(s) with functional groups for imparting crosslinkablilty are applied in the present invention, the aqueous emulsion is preferably combined with a crosslinking agent (i.e. so that crosslinking takes place e.g. after the formation of a coating therefrom). For example, comonomer(s) with hydroxyl functional groups for imparting crosslinkablilty are used in combination with for example a polyisocyanate as crosslinking agent. Comonomer(s) with functional groups for imparting crosslinkablilty comprising ketone and/or aldehyde functional groups are used in combination with for example a polyamine or a polyhydrazide as crosslinking agent. An example of a suitable polyamine is isophorone diamine or a polyalkylene imine such as polyethylene imine, for example obtainable from BASF under the trade name Lupasol®. Examples of suitable polyhydrazides are adipic acid dihydrazide, oxalic acid dihydrazide, phthalic acid dihydrazide and terephthalic acid dihydrazide. A preferred polyhydrazide is adipic acid dihydrazide. A preferred combination of crosslinking agent and functional group for imparting crosslinkablilty when the aqueous emulsion is subsequently dried is the combination of adipic acid dihydrazide as crosslinking agent and at least one ketone group present in the comonomer with functional groups for imparting crosslinkablilty. Diacetone acrylamide (DAAM) is a preferred comonomer with ketone functional groups for use in combination with adipic acid dihydrazide. However in one embodiment of the present invention advantageously the vinyl copolymer (A) used in the present invention is substantially free of, more advantageously have no, ethylencially unsaturated crosslinkable monomers.

Ethylencially unsaturated monomers which may further improve the wet adhesion may be present in vinyl copolymer (A) and/or vinyl copolymer (B). Conveniently further improved wet adhesion may be obtained by copolymerization of at least one monomer selected from the group consisting of:
i) ureido functional ethylenically unsaturated monomer, such as those available commercially under the trade names Plex 6852-0, Evonik, combinations and/or mixtures thereof),
ii) tertiary-amine functional ethylenically unsaturated monomer [such as DMAEMA (dimethylamine ethylmethacrylate), and/or DMAEA (dimethylamine ethylacrylate)], and/or
iii) any suitable combination of i), ii) and iii) and/or mixtures thereof.

Vinyl copolymer(s) (A) and (B) are preferably obtained by aqueous emulsion polymerization. Such an aqueous emulsion polymerization process is, in itself, well known in the art and are described in for example Handbook Emulsion Polymerization: Theory and Practice, 1975, by D.C. Blackley (ISBN 978-0-85334-627-2). Such a process involves polymerizing the monomers in an aqueous medium and conducting polymerization using a free-radical yielding initiator and (usually) appropriate heating (e.g. 30 to 120° C.) and agitation (stirring) being employed. The aqueous emulsion polymerization can be effected using one or more conventional emulsifying agents, these being surfactants. Anionic, non-ionic, and anionic-non-ionic surfactants can be used, and also combinations of the three types; cationic surfactants can also be used.

Emulsion polymerization can be initiated using thermally decomposing initiators or redox couple initiators. Typical thermally decomposing initiators include persulphate salts, such as sodium, potassium, or ammonium persulphate, or organic azo functional initiators, such as for instance 2,2′-dimethyl-2,2′-azodipropiononitril (AlBN), 2,2′-Azodi(2-methylbutyronitrile) (AMBN), 2,2′-dimethyl-2,2′-azodipropiononitril, or 4,4′-Azobis(4-cyanovaleric acid). When using these initiators, emulsion polymerization is typically initiated at temperatures between 60 and 100° C., more preferred between 70 and 95° C. Typically, the concentration of thermally decomposing initiators is chosen between 0.25 and 5 wt-%, based on total monomer weight. Alternatively, radical polymerizations can also be started using redox reagents, where an oxidator, mostly peroxides, is reacted with a reductor, conveniently in the presence of a transition metal ion, yielding initiating radicals. Typical examples of peroxides may include hydrogen peroxide, t-butyl hydroperoxide, cumyl hydrogen peroxide, and the like. Reductors may be chosen from the group of i-ascorbic acid, sodium metabisulphite, Brugolite FF6, sodium formaldehyde sulphoxylate, fructose, and the like. As transition metal ion normally ferrous or ferric ions are chosen, often as iron EDTA complex. Redox couple initiation can typically be done at temperatures between 10 and 100° C., more conveniently between 20 and 90° C., depending on the choice of reactants. Redox couple initiators are typically used in concentrations between 0.2 and 3 wt. %, based on total monomer weight.

The molecular weight of vinyl copolymer(s) (A) and (B) can be controlled by the use of well-known chain transfer agents. Preferred chain transfer agents can include mercaptanes and alkyl halogenides. More preferred, the chain transfer agent is selected from the group of lauryl mercaptane, 3-mercapto propionic acid, i-octyl thioglycolate, mercaptoethanol, tetrabromo methane, or tribromo methane. Most preferred the chain transfer agent is a mercaptane, selected from the group of lauryl mercaptane, 3-mercapto propionic acid, i-octyl thioglycolate, and mercaptoethanol.

Preferably the aqueous emulsion according to the invention contain latex particles having a diameter from 30 to 900 nanometers (nm), particularly 30 to 300 nm, more preferably from 60 to 200 nm.

The present invention further relates to a coating composition comprising the aqueous emulsion according to the present invention and further comprising solvents, pigments, dyes, heat stabilisers, defoamers, fillers, matting agents, UV absorbers and/or antioxidants. The coating composition according to the invention preferably does not contain any other binder than described above (i.e. vinyl copolymer(s) (A) and polymer(s) (B)). Hence, the amount of vinyl copolymer(s) (A) as described above is preferably also relative to the total weight amount of binder present in the coating composition according to the present invention.

Non-limiting examples of coating compositions are paints; overprint varnishes for example for paper or film; film coatings such as for example printable substrates, barrier coatings, primers, protective coatings; and inks for example for flexo printing, gravure printing and inkjet printing.

Preferably, the coating composition according to the invention is a one-component, non-crosslinkable composition, which, in the context of the present invention, is understood as a coating composition which does not need to be subjected to crosslinking upon drying to obtain a coating. Thus, the coating composition that is applied to a substrate does not need to contain a crosslinking component to obtain a coating, and thus the pot-life of one-component coating composition is longer than of coating composition to which a crosslinking component needs to be added in order to obtain a coating.

The present invention further relates to a method of coating a substrate comprising applying a coating composition according to the invention to a substrate and causing or allowing the aqueous carrier medium of the emulsion to be removed. The coating composition according to the invention may be applied to a wide variety of substrates. Preferred substrates are wood, optionally containing a primer and a midcoat, metal, plastic (for instance polypropylene or polyvinyl chloride), leather, glass, paper or a combination of at least two of these materials. The present invention further relates to a coated substrate obtained by this method.

The present invention is now further illustrated but in no way limited by reference to the following examples. Unless otherwise specified all parts, percentages, and ratios are on a weight basis.

Aqueous polymer emulsions are prepared as described below and further formulated as described below to obtain coating compositions of Examples 1-7 and Comparative Experiments 1-7. These coating compositions are used to cast films on a test card as described below and were tested on early water resistance, ethanol resistance and early blocking resistance as described below.

### Determination of Early Water Resistance

Films are cast on a test card (Leneta company) (250 micron wet film thickness at room temperature) and allowed to stand for 24 hours at 22° C. and 50% relative humidity. A spot of water is applied on the film and covered with cotton wool. Next, the water spot is taken off after 30 min exposure. The degree of whiteness and blistering of the film (where the spot was applied) is evaluated on a scale of 0=poor to 5=good; immediately after the removal of the water spot and after 24 hours.

### Determination of Ethanol Resistance

Films are cast on a test card (Leneta company) (100 micron wet film thickness at room temperature) and allowed to dry for 1 hour at room temperature. The films are then transferred to an oven at 50° C. and 30% relative humidity and left to age for 16 hours. Next, at room temperature two spots of an ethanol solution in water (48 wt-%) are applied on the films and covered with cotton wool. The first spot is taken off after 1 hour and the second spot after 6 hours. The degree of whiteness and blistering of the film (where the spots were applied) is evaluated on a scale of 0=poor to 5=good; immediately after the removal of the ethanol spot and after 24 hours.

### Determination of Early Blocking Resistance

Films with 250 micron wet film thickness are cast on a test card (Leneta company) at room temperature and allowed to dry for 24 hours at 22° C. and 50% relative humidity. The films are cut into pieces of 3.5 by 5 cm and placed side to side with the lacquered side on each other in a block tester (Koehler Instrument Company Blocking tester; spring no.2). A pressure of 1 kg/cm² is applied for 4 hours at 50° C. (in an oven). Next, the pieces are removed from the block tester and allowed to cool down for 30 minutes at room temperature. The pieces are separated from each other and the block resistance is assessed on a scale from zero to five (five meaning excellent test results, the pieces can be removed from each other without any visible damages; while zero means poor results, the pieces are completely adhered to each other and cannot be separated).

### EXAMPLE 1: COATING COMPOSITION CONTAINING A MULTIPHASE ACRYLIC COPOLYMER EMULSION According to the Invention

To a round-bottomed reactor equipped with a stirrer, condenser, nitrogen adapter, and a thermocouple are added 518.2 parts of demineralised water, 0.5 parts of sodium bicarbonate, 0.9 parts of a 25% solution of ammonia in water, and 31.0 parts of surfactant Rhodafac RS/710E-30. The reactor contents are heated to 85° C. At 85° C. a solution of 0.5 parts of ammonium persulphate in 5.3 parts of demineralised water is added immediately followed by 5% of a first monomer feed, which consists of 185.6 parts of demineralised water, 0.2 parts of sodium bicarbonate, 9.2 parts of Rhodafac RS/710E-30, 138.0 parts of isobornyl methacrylate, 138.0 parts of 2-octyl acrylate, 157.3 parts of butyl acrylate, 96.6 parts of methyl methacrylate, and 22.1 parts of acrylic acid, and has been stirred into a stable pre-emulsion first. The temperature will rise with approximately 5° C., after which the temperature of the reactor contents are stabilized at 89° C. As soon as the polymerization temperature of 89° C. is reached, feeding of the remainder of the first monomer feed is started, together with 70% of an initiator feed, which consists of 65.9 parts of demineralised water, 0.2 parts of sodium bicarbonate, 2.3 parts of ammonium persulphate, 0.1 parts of a 25% solution of ammonia in water, and 5.4 parts of Rhodafac RS/710E-30. Both feeds should be added over a period of 90 minutes.

At the end of the feeds, 1.1 parts of a 25% solution of ammonia in water diluted with 1.3 parts of demineralised water are added and the reactor contents are kept at 89° C. for 45 minutes. The T_{g} of the copolymer is +6° C.

At the end of the 45 minutes waiting time, a second monomer feed, which consists of 106.1 parts of demineralised water, 0.3 parts of sodium bicarbonate, 8.1 parts of Rhodafac RS/710E-30, 22.5 parts of butyl acrylate, 204.6 parts of methyl methacrylate, and 9.5 parts of acrylic acid, and has been stirred into a stable pre-emulsion first, and feeding of the remainder of the initiator feed are started. Both feeds should take 30 minutes. When the second monomer feed is completed the feed vessel is rinsed with 8.8 parts of demineralised water, which are then added to the reactor. The temperature is kept at 89° C. for 30 minutes after which the reactor contents are cooled to 70° C.

A mixture of 4.6 parts of a 25% solution of ammonia in water and 21.4 parts of demineralised water are added to the reactor over a period of 5 minutes.

At 70° C. a mixture of 1.7 parts of a 70 wt-% solution of t-butyl hydroperoxide in water and 8.8 parts of demineralised water is added to the reactor, followed by the addition of 0.8 parts of iso-ascorbic acid dissolved in 17.7 parts of demineralised water over a period of 30 minutes. The pH of this solution is adjusted to 7 first, using a 25% solution of ammonia in water. The T_{g} of the copolymer obtained from the second monomer feed is +80° C.

The reactor contents are cooled to room temperature, after which 5.6 parts of a 10 wt-% solution of benzisothiazolinon in water are added, the solids content of the copolymer emulsion is corrected to 45% using demineralised water, and the copolymer emulsion is filtered over a 200 mesh filter cloth.

Solids content of the emulsion is 45%, and pH is 6.5.

The solids content of the aqueous copolymer emulsion is adjusted to 42.8% solids, followed by addition of 1.0 wt-% on total weight of binder of co-solvent Texanol and 1.0 wt-% on total weight of binder of defoamer Dapro DF-7580. The pH of Dapro DF-7580 is adjusted to 7 with a 25% solution of ammonia in water. 0.14 wt-% on total weight of binder defoamer TegoFoamex 810 is added and the viscosity of the formulated binder is adjusted to 20-30 s DIN cup 4 with thickener Borchigel (1:1 with water).

### EXAMPLE 2: COATING COMPOSITION CONTAINING A MULTIPHASE ACRYLIC COPOLYMER EMULSION ACCORDING TO THE INVENTION

The process according to Example 1 is repeated, where the composition of the first monomer feed is set as presented in Table 1. The T_{g} of the copolymer obtained from the first monomer feed is also +6° C.

### COMPARATIVE EXPERIMENTS 1 AND 2: COATING COMPOSITION CONTAINING A MULTIPHASE ACRYLIC COPOLYMER EMULSION NOT ACCORDING TO THE INVENTION

The process according to Example 1 is repeated, where the compositions of the first monomer feeds are set as presented in Table 1. The T_{g} of the copolymer obtained from the first monomer feed is also +6° C.

TABLE 1

| | | | Comp. | Comp. |
|---|---|---|---|---|
| | Ex. 1 | Ex. 2 | Ex. 1 | Ex. 2 |
| Demineralised water | 185.6 | 185.6 | 185.6 | 185.6 |
| Sodium bicarbonate | 0.2 | 0.2 | 0.2 | 0.2 |
| Rhodafac RS/710E-30 | 9.2 | 9.2 | 9.2 | 9.2 |
| Isobornyl methacrylate (iBOMA) | 138.0 | 49.7 | | |
| 2-octyl acrylate (2-OA) | 138.0 | 115.9 | | |
| Dibutyl itaconate (DBI) | | | 165.6 | |
| Dimethyl itaconate (DMI) | | | | 270.5 |
| Butyl acrylate | 157.3 | 165.6 | 198.7 | 259.5 |
| Methyl methacrylate | 96.6 | 198.7 | 165.6 | |
| Acrylic acid | 22.1 | 22.1 | 22.1 | 22.1 |

### EXAMPLE 3: COATING COMPOSITION CONTAINING A SINGLE PHASE ACRYLIC COPOLYMER EMULSION ACCORDING TO THE INVENTION

To a round-bottomed reactor equipped with a stirrer, condenser, nitrogen adapter, and a thermocouple are added 398.3 parts of demineralised water and 21.1 parts of a 30 wt-% solution of sodium lauryl sulphate in water. The reactor contents are heated to 70° C.

At 70° C. 10% of a monomer feed, which consists of 366.4 parts of demineralised water, 8.9 parts of a 30 wt-% solution of sodium lauryl sulphate in water, 244.7 parts of styrene, 78.9 parts of butyl acrylate, 236.8 parts of isobornyl methacrylate, 157.9 parts of 2-octyl acrylate, 39.5 parts of diacetone acrylamide, and 31.6 parts of acrylic acid, and has been mixed into a stable pre-emulsion first, is added, followed by a solution of 0.8 parts of ammonium persulphate in 3.2 parts of demineralised water and the reactor contents are further heated to 85° C.

At 85° C. the additions of the remainder of the monomer feed and of an initiator feed, consisting of 89.4 parts of demineralised water, 3.2 parts of ammonium persulphate, and 1.6 parts of a 30 wt-% solution of sodium lauryl sulphate in water are started. Both feeds should take 180 minutes. At the end of the feeds, the monomer feed vessel is rinsed with 14.1 parts of demineralised water, which are then added to the reactor, and the reactor contents are stirred at 85° C. for 30 minutes.

The temperature is cooled to 70° C. At 70° C., a solution of 0.5 parts of iso-ascorbic acid in 17.8 parts of demineralised water is added to the reactor over a period of 30 minutes. Simultaneously, a mixture of 3.2 parts of demineralised water, 0.2 parts of a 30 wt-% solution of sodium lauryl sulphate in water, and 0.7 parts of a 70 wt-% solution of t-butyl hydroperoxide in water is added over the same period, divided in three equal shots which are added at the start of the iso-ascorbic acid feed, after 10 minutes following the start of the iso-ascorbic acid feed and after 20 minutes.

At the end of the iso-ascorbic acid feed, the temperature is kept at 70° C. for 30 minutes, after which the reactor contents are cooled to 35° C. and a mixture of 19.2 parts of demineralised water and 10.1 parts of a 25% solution of ammonia in water is added, followed by 5.4 parts of a 10 wt-% solution of benzisothiazolinon in 3.5 parts of demineralised water. The pH is corrected to 7 using a 25% solution of ammonia in water, after which 14.2 parts of adipic dihydrazide and 28.9 parts of demineralised water are added. Solids content of the copolymer emulsion is corrected to 45% using demineralised water and the emulsion is filter over a 200 mesh filter cloth. The T_{g} of the copolymer is +45° C.

The solids content of the aqueous copolymer emulsion is adjusted to 35.5% solids, followed by adding 7.15 wt-% on total weight of binder of co-solvent butyl glycol and 2.0 wt-% on total weight of binder of co-solvent Dowanol TPnB. Next, 0.22 wt-% on total weight of binder of defoamer Tego Airex 902W is added followed by 1.25 wt-% of thickener Rheolate FX1070 (1:1 with water).

### EXAMPLE 4: COATING COMPOSITION CONTAINING A SINGLE PHASE ACRYLIC COPOLYMER EMULSION ACCORDING TO THE INVENTION

The process according to Example 3 is repeated, where the composition of the monomer feed is set as presented in Table 2. The T_{g} of the copolymer is +45° C.

### COMPARATIVE EXPERIMENTS 3 AND 4: COATING COMPOSITION CONTAINING A SINGLE PHASE ACRYLIC COPOLYMER EMULSION NOT ACCORDING TO THE INVENTION

The process according to Example 3 is repeated, where the compositions of the monomer feeds are set as presented in Table 2. The T_{g} of the copolymer is +45° C.

TABLE 2

| | | | Comp. | Comp. |
|---|---|---|---|---|
| | Ex. 3 | Ex. 4 | Ex. 3 | Ex. 4 |
| Demineralised water | 366.4 | 366.4 | 366.4 | 366.4 |
| Sodium lauryl sulphate (30%) | 8.9 | 9.0 | 8.9 | 9.0 |
| Styrene | 244.7 | 421.6 | 197.3 | 318.2 |
| Butyl acrylate | 78.9 | 103.4 | 126.3 | 190.9 |
| Isobornyl methacrylate (iBOMA) | 236.8 | 119.3 | | |
| 2-octyl acrylate (2-OA) | 157.9 | 119.3 | | |
| Dimethyl itaconate (DMI) | | | 260.5 | 254.6 |
| Dibutyl itaconate (DBI) | | | 134.2 | |
| Diacetone acrylamide* | 39.5 | | 39.5 | |
| Acrylic acid | 31.6 | 31.8 | 31.6 | 31.8 |

*When no diacetone acrylamide is added, adipic dihydrazide is also not added.

### EXAMPLE 5: COATING COMPOSITIONS CONTAINING A POLYELECTROLYTE STABILISED COPOLYMER EMULSION ACCORDING TO THE INVENTION

### Preparation of the Polyelectrolyte Stabiliser

To a round-bottomed reactor equipped with a stirrer, condenser, nitrogen adapter, and a thermocouple are added 5210.4 parts of demineralised water, and 14.7 parts of a 30 wt-% solution of sodium lauryl sulphate in water and the reactor contents are heated to 80° C. At 80° C., 10% of an emulsified monomer feed, consisting of 947.6 parts of demineralised water, 44.1 parts of 30 wt-% solution of sodium lauryl sulphate in water, 18.8 parts of 3-mercaptopropionic acid, 37.6 parts of lauryl mercaptane, 188.0 parts of methacrylic acid, and 2162.1 parts of methyl methacrylate, which has been stirred into a stable pre-emulsion, is added. After 5 minutes a solution of 2.1 parts of ammonium persulphate in 106.7 parts of demineralised water is added and the temperature is raised to 85° C. At 85° C. feeding of the remaining monomer feed and an initiator feed, consisting of 4.9 parts of ammonium persulphate and 324.1 parts of demineralised water is started. Both feeds should take 60 minutes. As soon as the monomer feed is completed, the feed vessel is rinsed with 48.8 parts of demineralised water, which are subsequently added to the reactor phase. The temperature is maintained at 85° C. for another 30 minutes, after which the reactor contents are cooled to 80° C. At 80° C., a mixture of 136.6 of a 25% solution of ammonia in water and 204.6 parts of demineralised water is added over a period of 15 minutes followed by 48.8 parts of demineralised water. The pH is adjusted to 8.0 using a 25% solution of ammonia in water, and the solids content is adjusted to 25.9% using demineralised water. The reactor contents are cooled to room temperature and filtered using a 200 mesh filter cloth.

### Polyelectrolyte Stabilised Copolymer Emulsion According to the Invention

To a round-bottomed reactor equipped with a stirrer, condenser, nitrogen adapter, and a thermocouple are added 875.7 parts of the polyelectrolyte stabilizer prepared as described above, 3.6 parts of a 30 wt-% solution of sodium lauryl sulphate in water, and 208.4 parts of demineralised water. The reactor contents are heated to 50° C. At 50° C., charge to the reactor one third of a monomer feed consisting of 98.3 parts of methyl methacrylate, 163.2 parts of butyl acrylate, 52.9 parts of isobornyl methacrylate, and 209.2 parts of 2-octyl acrylate and mix for 15 minutes. Next, charge one third of a mixture of 1.6 parts of a 70 wt-% solution of t-butyl hydroperoxide in water and 2.1 parts of demineralised water, followed by a mixture of 0.1 parts of a 1 wt-% solution of Iron(III)EDTA in water and 1.0 part of demineralised water. Next, 27% of a solution of 1.9 parts of iso-ascorbic acid in 60.7 parts of demineralised water is added over a period of 15 minutes. The pH of this solution is adjusted to 7.5 first using a 25% solution of ammonia in water.

After the temperature rise has stopped, the mixture is stirred at peak temperature for 10 minutes and 50% of 43.4 parts of demineralised water are added and the reactor contents are cooled to 50° C.

At 50° C., half of the remaining monomer mixture is added to the reactor and mixed for 15 minutes. Half of the remaining t-butyl hydroperoxide/water mixture is added and again 27% of the original iso-ascorbic acid solution is fed over a period of 15 minutes. After the temperature rise has stopped, the mixture is stirred at peak temperature for 10 minutes and the remaining 50% of 43.4 parts of demineralised water are added and the reactor contents are cooled to 50° C.

At 50° C., the remaining monomer mixture is added to the reactor and mixed for 15 minutes. The monomer feed vessel is rinsed with 21.7 parts of demineralised water which are added to the reactor, too. The remainders of the t-butyl hydroperoxide/water mixture are added to the reactor and again 27% of the original iso-ascorbic acid solution is fed over a period of 15 minutes. After the temperature rise has stopped, the mixture is stirred at peak temperature for 10 minutes, and the batch is cooled to 60° C.

At 60° C., a mixture of 1.0 part of t-butyl hydroperoxide and 1.3 parts of demineralised water are added to the reactor followed by the remainders of the iso-ascorbic acid solution and 30.7 parts of demineralised water. After mixing for another 20 minutes, the reactor contents are cooled to 30° C.

At 30° C., 19.3 parts of a 10 wt-% solution of benzisothiazolinon in water are added, the solids content is corrected to 42% using demineralised water, and the emulsion is filtered over a 200 mesh filter cloth. The T_{g} of the copolymer is −20° C.

A formulation is prepared by adding 4.0 wt-% on total weight of binder of butyl diglycol to the aqueous binder emulsion. Viscosity of the formulated resin is adjusted to 20-30 s DIN cup 4 with Borchigel L75 (1:1 with water).

### EXAMPLES 6 AND 7: COATING COMPOSITIONS CONTAINING POLYELECTROLYTE STABILISED COPOLYMER EMULSION ACCORDING TO THE INVENTION

The process according to Example 5 is repeated, where the composition of the monomer feed of the copolymer prepared in the presence of the polyelectrolyte stabilize are set as presented in Table 3. The T_{g} of the copolymer is +20° C. The aqueous binder emulsion is formulated by adding 10.0 wt-% on total weight of binder of butyl diglycol. Viscosity of the formulated resins is adjusted to 20-30 s DIN cup 4 with Borchigel L75 (1:1 with water).

TABLE 3

| | Ex. 5 | Ex. 6 | Ex. 7 |
|---|---|---|---|
| Methyl methacrylate | 98.3 | 245.2 | 185.6 |
| Butyl acrylate | 163.2 | 16.2 | 180.4 |
| Isobornyl methacrylate (iBOMA) | 52.3 | 52.3 | 109.8 |
| 2-octyl acrylate (2-OA) | 209.2 | 209.2 | 47.1 |

### COMPARATIVE EXPERIMENT 5: COATING COMPOSITIONS CONTAINING POLYELECTROLYTE STABILISED COPOLYMER EMULSION NOT ACCORDING TO THE INVENTION

Example 5 is repeated where the composition of the monomer feed is set as presented in Table 4. The T_{g} of the copolymer is −20° C.

### COMPARATIVE EXPERIMENTS 6 AND 7: COATING COMPOSITIONS CONTAINING POLYELECTROLYTE STABILISED COPOLYMER EMULSION NOT ACCORDING TO THE INVENTION

Example 6 is repeated where the composition of the monomer feed is set as presented in Table 4. The T_{g} of the copolymer is +20° C.

TABLE 4

| | Comp. | Comp. | Comp. |
|---|---|---|---|
| | Ex. 5 | Ex. 6 | Ex. 7 |
| Methyl methacrylate | 164.7 | 15.7 | 163.2 |
| Butyl acrylate | 96.7 | 350.3 | 202.9 |
| DBI | 261.5 | | |
| DMI | | 156.9 | 156.9 |

The coating compositions of Examples 1-7 and Comparative Experiments 1-7 were tested on early water resistance, ethanol resistance and early blocking resistance as described above. Results are shown in Tables 5-8.

TABLE 5

| | 1 hr ethanol |
|---|---|
| | resistance |
| Ex. 1 | 3 |
| Ex. 2 | 3 |
| Comp. Ex. 1 | 0 |
| Comp. Ex. 2 | 0 |

TABLE 6

| | Early water | |
|---|---|---|
| | resistance (30 | 6 hrs ethanol |
| | min) | resistance |
| Ex. 3 | 4 | 4 |
| Ex. 4 | 5 | 4/5 |
| Comp. Ex. 3 | 1 | 1 |
| Comp. Ex. 4 | 2 | 1 |

TABLE 7

| | Early blocking |
|---|---|
| | resistance |
| Ex. 5 | 3/4 |
| Comp. Ex. 5 | 0 |

TABLE 8

| | 6 hrs ethanol |
|---|---|
| | resistance |
| Ex. 6 | 4 |
| Ex. 7 | 3 |
| Comp. Ex. 6 | 0/1 |
| Comp. Ex. 7 | 0 |

1. An aqueous emulsion comprising at least 30 wt. % of vinyl copolymer(s) (A), said vinyl copolymer(s) (A) containing the following monomers:
(I) isobornyl methacrylate and 2-octyl acrylate in a summed amount of at least 30 wt. %, in a weight ratio of isobornyl methacrylate to 2-octyl acrylate from 5:95 to 95:5;
(II) no more than 70 wt. % of at least one ethylenically unsaturated monomer other than 2-octyl acrylate and isobornyl methacrylate,
whereby the summed amount of (I) and (II) is 100 wt. % and whereby
the amount of vinyl copolymer(s) (A) is given relative to the total weight amount of binder present in the emulsion.

2. An emulsion according to claim 1, wherein the vinyl copolymer(s) (A) contains
(I) isobornyl methacrylate and 2-octyl acrylate in a summed amount of at least 40 wt. %, in a weight ratio of isobornyl methacrylate to 2-octyl acrylate from 5:95 to 95:5;
(II) no more than 60 wt. % of at least one ethylenically unsaturated monomer other than 2-octyl acrylate and isobornyl methacrylate,
whereby the summed amount of (I) and (II) is 100 wt. %.

3. An emulsion according to claim 1, wherein the weight ratio of isobornyl methacrylate to 2-octyl acrylate is from 15:85 to 85:15.

4. An emulsion according to claim 1, wherein the glass transition temperature of the vinyl copolymer(s) (A) is in the range from −30° C. to 80° C., whereby the glass transition temperature is determined according to the method as disclosed in this specification.

5. An emulsion according to claim 1, wherein the amount of vinyl copolymer(s) (A) present in the emulsion is 100 wt. %, relative to the total weight amount of binder present in the emulsion, and the monomers (II) in the vinyl copolymer(s) (A) contains the following monomers
(IIa) from 0.1 to 10 wt. %, preferably from 0.1 to 5 wt. % of carboxylic acid functional ethylenically unsaturated monomer(s);
(IIb) from 0 to 5 wt. % of ethylenically unsaturated crosslinkable monomer, different from (IIa);
(IIc) from 0 to 5 wt. % of ethylenically unsaturated wet adhesion promotor monomer, different from (IIa) and (IIb);
(IId) from 50 to 69.9 wt. %, preferably from 55 to 69.9 wt. % of ethylenically unsaturated monomer(s), different from (IIa), (IIb) and (IIc);
whereby the amounts of (IIa), (IIb), (IIc) and (IId) are given relative to the total amount of (I) and (II).

6. An emulsion according to claim 2, wherein the amount of vinyl copolymer(s) (A) present in the emulsion is 100 wt. %, relative to the total weight amount of binder present in the emulsion, and the monomers (II) in the vinyl copolymer(s) (A) contains the following monomers
(IIa) from 0.1 to 10 wt. %, preferably from 0.1 to 5 wt. % of carboxylic acid functional ethylenically unsaturated monomer(s);
(IIb) from 0 to 5 wt. % of ethylenically unsaturated crosslinkable monomer, different from (IIa);
(IIc) from 0 to 5 wt. % of ethylenically unsaturated wet adhesion promotor monomer, different from (IIa) and (IIb);
(IId) from 40 to 59.9 wt. %, preferably from 45 to 59.9 wt. % of ethylenically unsaturated monomer(s), different from (IIa), (IIb) and (IIc);
whereby the amounts of (IIa), (IIb), (IIc) and (IId) are given relative to the total amount of (I) and (II).

7. An emulsion according to claim 5, wherein monomer (IIa) is acrylic acid and/or methacrylic acid.

8. An emulsion according to claim 5, wherein monomers (IIb), (IIc) and (IId) are selected from the group consisting of acrylates, methacrylates, arylalkylenes and any mixture thereof.

9. An emulsion according to claim 5, wherein monomer (IId) is selected from the group consisting of methyl (meth)acrylate, ethyl (meth)acrylate, butyl (meth)acrylate, styrene and combinations thereof.

10. An emulsion according to claim 5, wherein the vinyl copolymer(s) (A) do not contain monomer (IIb) and/or monomer (IIc).

11. An emulsion according to claim 5, wherein the glass transition temperature of the vinyl copolymer(s) (A) is in the range from 20° C. to 60° C., preferably in the range from 40° C. to 60° C., whereby the glass transition temperature is determined according to the method as disclosed in this specification.

12. An emulsion according to claim 5, wherein the glass transition temperature of the vinyl copolymer(s) (A) is in the range from −20° C. to 20° C., whereby the glass transition temperature is determined according to the method as disclosed in this specification.

13. An emulsion according to claim 1, wherein the emulsion comprises a first vinyl copolymer (A1) and a second vinyl copolymer (A2), both containing monomers, whereby the first vinyl copolymer (A1) is obtained by emulsion polymerization and the second vinyl copolymer (A2) is obtained by emulsion polymerization in the presence of the first vinyl copolymer (A1) and whereby the glass transition temperature of the vinyl copolymer (A1) is in the range from −20° C. to 20° C. and the glass transition temperature of the vinyl copolymer (A2) is in the range from 60° C. to 120° C., whereby the glass transition temperature is determined according to the method as disclosed in this specification.

14. An emulsion according to claim 1, wherein the emulsion further comprises at least one second polymer (B) different from vinyl copolymer (A), whereby the weight ratio of vinyl copolymer(s) (A) to polymer(s) (B) is in the range from 90:10 to 50:50 and whereby the total amount of vinyl copolymer(s) (A) and polymer(s) (B) present in the emulsion is 100 wt. %, relative to the total weight amount of binder present in the emulsion.

15. An emulsion according to claim 14, wherein the second polymer (B) is a vinyl copolymer (B); the vinyl copolymer (A) and vinyl copolymer (B) are obtained by a process comprising steps:
a) a first polymerization step, to form the vinyl copolymer (A);
b) a second polymerization step effected in the presence of the resulting first phase vinyl copolymer (A) obtained in step a) to form the second phase vinyl copolymer (B).

16. An emulsion according to claim 14, wherein monomer (II) in the vinyl copolymer (A) contains from 0.1 to 15 wt. %, preferably from 0.1 to 10 wt. %, more preferably from 1 to 5 wt. % of carboxylic acid functional ethylenically unsaturated monomer, whereby the amount of carboxylic acid functional ethylenically unsaturated monomer is given relative to the total amount of (I) and (II).

17. An emulsion according to claim 16, wherein the vinyl copolymer (B) contains the following monomers:
(IB) from 0.1 to 10 wt. %, preferably from 0.1 to 5 wt. %, more preferably from 1 to 3.5 wt. % of carboxylic acid functional ethylenically unsaturated monomer;
(IIB) from 90 to 99.9 wt. %, preferably from 95 to 99.9 wt. %, more preferably from 96.5 wt. % to 99 wt. % of ethylenically unsaturated monomer, different from (IB);
whereby the amounts of (IB) and (IIB) are given relative to the total weight amount of monomers used to prepare the vinyl copolymer (B).

18. An emulsion according to claim 17, wherein monomers (IIB) are selected from the group consisting of acrylates, methacrylates, arylalkylenes and any mixture thereof.

19. An emulsion according to claim 14, wherein the second polymer (B) is a vinyl copolymer (B) and the vinyl copolymers (A) and (B) are obtained by a process comprising steps:
a) preparing a first phase carboxylic acid-functional vinyl copolymer (B) by emulsion polymerization of a monomer composition B in the presence of a chain-transfer agent, whereby monomer composition B contains:
Bi) at least one carboxylic acid functional ethylenically unsaturated monomer; and
Bii) at least one ethylenically unsaturated monomer different than Bi); and
b) preparing a second phase vinyl copolymer (A) by emulsion polymerization of a monomer composition A in the presence of the resulting first phase vinyl copolymer (B) from step a) where the monomer composition A contains the following monomers:
(I) isobornyl methacrylate and 2-octyl acrylate in a summed amount of at least 30 wt. %, in a weight ratio of isobornyl methacrylate to 2-octyl acrylate from 5:95 to 95:5;
(II) no more than 70 wt. % of at least one ethylenically unsaturated monomer other than 2-octyl acrylate and isobornyl methacrylate, whereby the summed amount of (I) and (II) is 100 wt. %;
where the acid value of vinyl copolymer (A) is lower than the acid value of vinyl copolymer (B); the weight average molecular weight (Mw) of vinyl copolymer (A) is higher than the weight average molecular weight (Mw) of vinyl copolymer (B); and
where at least part of the carboxylic acid groups of vinyl copolymer (B) are deprotonated to obtain ionic or potentially ionic water-dispersing groups prior to step b).

20. An emulsion according to claim 15, wherein the glass transition temperature of vinyl copolymer (B) is higher than the glass transition temperature of vinyl copolymer (A), whereby the difference in glass transition temperature between vinyl copolymer (B) and vinyl copolymer (A) is preferably at least 20° C., more preferably at least 30° C., even more preferably at least 40° C., whereby the glass transition temperature is determined according to the method as disclosed in this specification.

21. An emulsion according to claim 15, wherein the glass transition temperature of the vinyl copolymer (A) is in the range from −20° C. to 20° C., whereby the glass transition temperature is determined according to the method as disclosed in this specification.

22. An emulsion according to claim 1, wherein the weight average molecular weight of vinyl copolymer (A) is higher than 50,000 g/mol, more preferably higher than 80,000 g/mol, even more preferably higher than 200,000 g/mol; preferably lower than 10,000,000 g/mol and more preferably lower than 4,000,000 g/mol, whereby the weight average molecular weight is determined according to the method as disclosed in this specification.

23. An emulsion according to claim 19, wherein vinyl copolymer (B) has a weight average molecular weight (Mw) less than 100,000 g/mole and higher than 2,000 g/mol, preferably less than 75,000 g/mol, more preferably less than 50,000 g/mol and the weight average molecular weight of vinyl copolymer (B) is most preferably from 10,000 to 35,000 g/mol, whereby the weight average molecular weight is determined according to the method as disclosed in this specification.

24. An emulsion according to claim 14, wherein polymer (B) is a polyester, a polyesteramide, a polyamide or a polyurethane.

25. An emulsion according to claim 1, wherein the emulsion comprises vinyl copolymer(s) (A) in an amount of at least 50 wt. %, more preferably of at least 70 wt. %, whereby the amount of vinyl copolymer (A) is given relative to the total weight amount of the binder present in the emulsion.

26. A coating composition comprising an aqueous emulsion according to claim 1 and further comprising solvents, pigments, dyes, heat stabilisers, defoamers, fillers, matting agents, UV absorbers and/or antioxidants.

27. A coating composition according to claim 26, wherein the composition is a one-component, non-crosslinkable composition.

28. A method of coating a substrate comprising applying a coating composition according to claim 26 to a substrate and causing or allowing the aqueous carrier medium of the emulsion to be removed.

29. A method according to claim 28, wherein the substrate is wood, optionally containing a primer and a midcoat, metal, plastic (for instance polypropylene or polyvinyl chloride), leather, glass, paper or a combination of at least two of these materials.

30. A coated substrate obtained by the method of claim 29.
